(19) United States
(12) Patent Application Publication
(10) Pub. No.: US 2004/0267622 A1
(43) Pub. Date: Dec. 30, 2004

(54) Taylor corp.pre-paid cash cards unlimited

(76) Inventors: John David Taylor, Vernon, TX (US); Steve Kimbell Taylor, Vernon, TX (US)

Correspondence Address: John D. Taylor, Steve K. Taylor, Taylor Corp: Pre-Paid Cash Cards Unlimited, 2204 Stephens St., Vernon, TX, 76384, US

(21) Appl. No.: 09/973,626

(22) Filed: Jan. 10, 2002

(51) Int. Cl. G06K 7/08

(52) U.S. Cl. 705/26; 235/449

(57) ABSTRACT

A Taylor pre-paid cash card, is a card spent as cash at any market that has a scan system to except it. A safeway to carry large amounts of cash in a card. The value of the card is worth what you pay for it, less a small user fee. As the card is spent, a receipt is given for amount spent, and a remaining balance. Use it up, throw away the card and buy another. A cash card used by the means of electronic transfer. A plastic card carried in your wallet. The card has a pin # and printed numbers with magnet stripes to identify card value. Assorted colors for priced cards with a bar code on the front. Cash Cards have company information and a secondary bar code on the back. A all public cash card, bought and sold to the public, by public markets.

### BACKGROUND OF THE INVENTION

1. Technical Field of the Invention

The present invention relates to a cash card sold through public markets, companies, firms or related financial institutions to any person. Cash cards are sold for money, to be spent as money, through the use of a utility service for electronic transactions. Cash cards can be spent at any market that has a scan system or any electronic transfer systems. Cash card value is worth what you pay for it. Less a small user fee.

2. Description of Related Art

A variety of different size valued cash cards are used by financial instruments of commerce, to receive payment and provide payment in exchange for cash money that is appropriated by the sale of cash cards sold to the public, from market outlets of commerce that execute the spent money invested in the cash cards.

Unlike, bank check cards, bank debit cards, or gift cards, sold through chosen banks or outlet markets, generally spent at only their places of business in their vicinity, rarely redeemable to receive cash back. However pre-paid cash cards can be sold by outlet markets too any and all public users for money, and be spent and receive money through the utility service of electronic transfer.

Pre-Paid Cash Cards are associated with a Utility service available from many merchants. Funds are instantly transferred when a cash card is bought or spent, whereas credit cards are not. Credit cards, check cards, gift cards and debit cards have a set spending limit, but a pre-paid cash card has a certain size instant cash value based on many different size valued cash cards.

Pre-Paid cash cards have a certain value that is electronically transferred through the use of a utility service, from the card buyer to the merchant. As spent, from the merchant to the card holder. When the cash card is bought from a merchant, the cash card and value is activated by electronic means from the merchant source. As the cash card is spent, it is run through a electronic utility transfer system, where a balance and receipt is given to the cash card holder.

Pre-Paid Cash Cards have a set amount of money paid for the cash cards value size, of which are sold as a small, medium or large cash card. Depending on the value size needed by the buyer.

As pre-paid cash cards are bought and activated, the money is electronically transferred to financial institutions and posted. As cash cards are spent, the financial institutions electronically send the money back through to the to the place where the cash card is spent leaving a receipt and balance left in the cash card, for the customer.

Accordingly there is a need for pre-paid cash cards by the Internet Pre-paid cash cards can be used by electronic transfer for instant cash transactions. Electronic transactions is the Internets most popular means of business. Credit card numbers are asked for on almost every sale through Internet sales. I submit that instant cash, by use of a pre-paid cash card is much better an faster for any purchase or sale.

Accordingly a Taylor Corp: Pre-Paid Cash Card is a hand held wallet size card with a color, value print, a number code, bar code and a electronic magnet strip for value information. A ID No. for owner cash card protection. A safe way to carry large amounts of cash in a card and on your person. A cash card that is sold to the public for cash, by a market outlet or commercial financial institution that execute the transactions of the cash card, by means of a utility transaction service. That is spent as cash by the cash card holder.

### BRIEF SUMMARY OF THE INVENTION

In explaining the present invention in detail the invention in its application of other embodiment and the purpose of description. In accordance this invention is a superior cash card like no other that has ever been. As many ways as you can spend cash, is as many ways as you can spend a Taylor Corp: Pre-Paid Cash Card Unlimited, cash card. For the purpose used, there has never been the like, until now. Truly a First Original, All Public, Pre-Paid Cash Card.

As to several aspects, the present invention includes a variety of codes in the cash card that allow it to be used for many purposes. One aspect is to be bought through public markets for cash and in return spent as cash at any utility electronic transfer system. Much like credit cards, except the cash card is used for cash not credit.

By purchasing a pre-paid cash card, the cash card is activated at the point of sale, for the amount of purchase. Cash cards bought with money, to be spent like money or receive cash back through the use of electronic utility transactions. Cash cards is a instant cash payment upon use. Whereas debit cards pulse cards, gift cards or bank check cards most generally are not instant cash payment.

By using the code numbers and ID numbers, placed on the front of the cash cards. The Taylor cash cards can be use to make purchases from the internet for any desired purchase, up to the amount of money or balance of cash in the cash card. A instant cash payment through the use of a utility electronic transfer system.

Accordingly a cash card has bar codes so the central computers can keep tract of the transactions of commerce that execute the process that provide exchange payment between the financial institution and consumers that hold and spend the activated pre paid cash cards.

Accordingly a Taylor Pre-Paid Cash Card is a hand held wallet size plastic card of assorted colors representing assorted value size pre paid cash cards, having a price, a number code, bar code and printed on the front of each cash card along with logos pictures and mottos for commercial service. Likewise on the reverse side there is a ID # for card activation and personal card protection. There is a 1-800 number for customer information, also magnet strip for value and balance information and a secondary bar code containing information of remaining card contents, to replace the magnet strip in case the strip is damaged in any way.

A registered certificate of copyright has been given to Taylor Corp: Pre-Paid Cash Cards Unlimited and text materials for pre-paid cash cards, effective date of registration Mar. 27, 2000, by the Library of Congress Copyright Office. Certificate of Registration No. Form PA 1-823-882 Examiner Michael Goldstein. A registered publication from U.S. Copyright Office.

### BRIEF DESCRIPTION OF THE DRAWINGS

The Figured Numbered drawing illustrate the invention of such drawing.

FIG. 1 The activation point of sale, of Pre-Paid cash card. Activated by utility commerce scan through a public market electronic transfer system

FIG. 2 Pre paid cash card activation posted from scan system to commerce market computers.

FIG. 3 Receiver of financial electronic funds from commerce market computers. And executors of returned cash or spent customer funds, by use of a utility transfer system.

FIG. 4 Spending the cash card through the scan system for instant cash or spending and getting a receipt and balance at point of spending

FIG. 5 Front view and facts of the Pre Paid Cash Cards.

(i) Title of cash card; Taylor Corp: Pre-Paid Cash Cards Unlimited

(ii) Numbers used for card tracking.

(iii) Printed value Cash Card Price.

(iv) Value Bar Code Tracker.

FIG. 6 Back view and facts of the Pre-Paid Cash Cards

(I) Cash Card personal ID number and activation code.

(ii) Secondary Bar Code information

(iii) A 1-800 phone Information contact number

(iv) Magnet Strip for activation and recorded value cash card information.

### DETAILED DESCRIPTION OF THE INVENTION

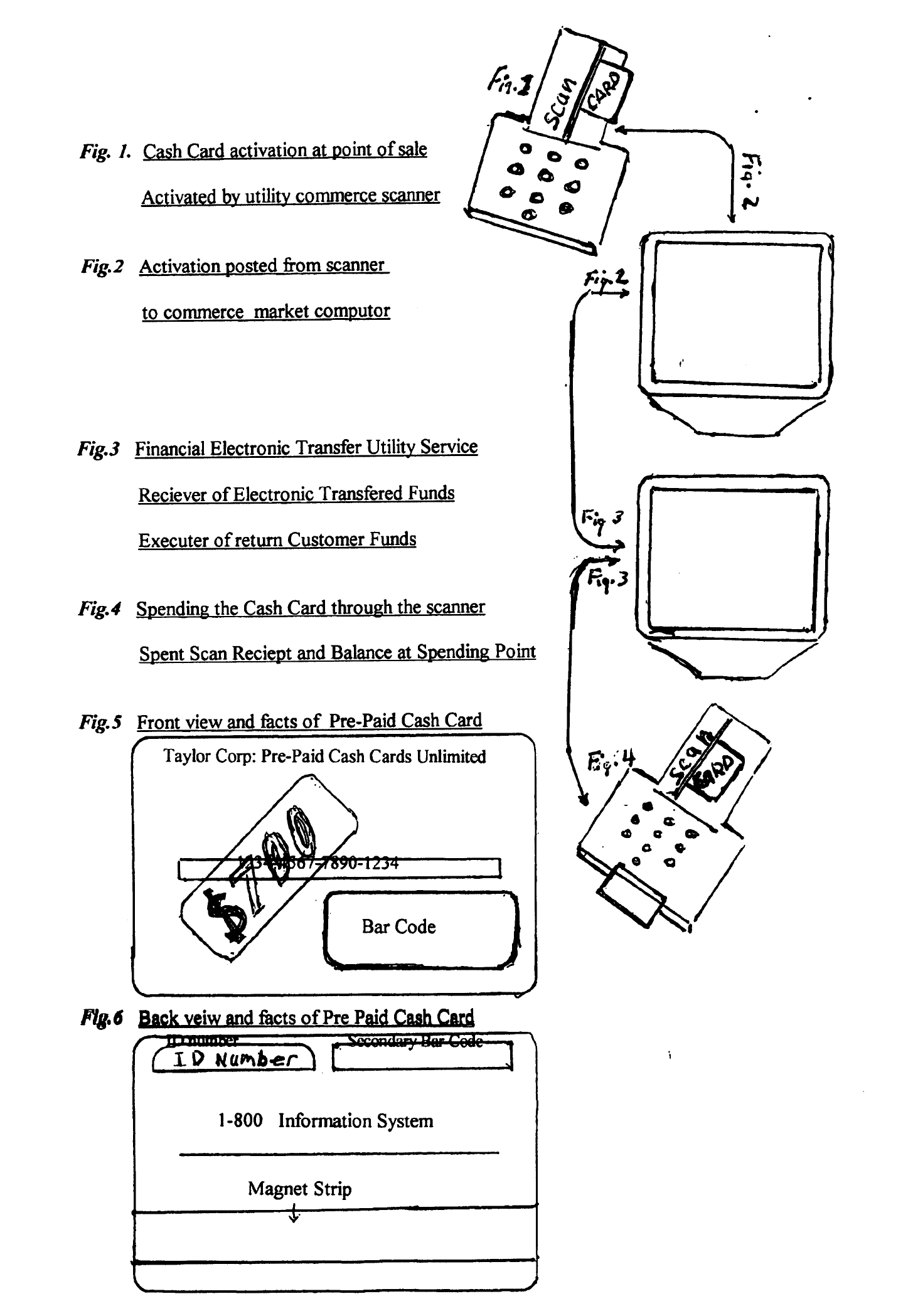

By a combination of the cash card being passed through the scan system and ID code number punched into scan system the Pre-Paid Cash Card becomes activated at the point of sale and can be spent or receive cash for the amount of money paid for the cash card. Referring to FIG. 1

With reference to FIG. 2 through the use of a utility service. The value cash card activation is transferred from the scan system to the commerce market control computer.

From the market control computer the activated cash card value is sent to a Financial Institution of electronic transaction utility service. That is the receiver of the paid funds activating the pre-paid cash cards. And is the executor that returns funds to the customer card user. Ref. FIG. 3

In referring to FIG. 5 and FIG. 6 of the cash card drawing is the product provided to the scan system to receive payment by means of electronic transfer. Referring to FIG. 4

In FIG. 5 is the front view of the Pre-Paid Cash card, which has a numbered tracker, printed price, commercial face pictures and a bar code that is used to create the pre paid cash card product.

The back view of the Pre-Paid Cash Card drawing FIG. 6 which are ID code number, magnet strip, secondary bar code, information number.

What I (we) is claimed is:

1. A method of operation of buying a card for cash money, from a market outlet or a commercial financial institution, money storied in a card, making the card a pre-paid cash card that can be spent as cash or to receive cash from a card, by the card purchaser through the use of a utility transfer service.
(I) Taylor Corp: Pre-Paid Cash Cards Unlimited is The First Original, All public superior pre paid cash card. The present invention is a prepaid cash card sold to the public for money by commercial markets, company firms and related financial institutions including the internet. Cash cards are sold to any person for money and a small user fee.
(ii) The pre-paid cash cards are a hand wallet size card that has assorted colors for assorted card values, a number code for tracking, a bar code for cash card values, a ID# for cash card owner protection, face of the cash card has printed pictures for commercial institutions for advertisement and a magnet strip for value information and cash card processing by use of a utility transaction service. The cash card has a secondary bar code on the back side in case the magnet strip is damaged for any reason. The secondary bar code retains the value information in the cash card.
(iii) Pre-Paid Cash Cards are cash cards bought with money by any of the public, to spend as cash for purchases or to receive cash from the cash card through electronic transfer from any public scan system of a utility commercial institution. Cash cards is a instant cash payment upon use or a instant cash refund from financial institutions of electronic transactions.
(iv) A variety of small, medium or large valued size pre-paid cash cards are sold to the public and are used by financial institutions of commerce to receive payment from the sold cash cards and provide exchange payment to the card customer. Accordingly pre paid cash cards can be spent at any financial institution of commerce or outlet markets for instant cash payment or cash return, up to the limit value of the cash card. By use of a utility electronic transactions service.
(vi) Each pre paid cash card has its own set of tracking numbers, bar codes and ID numbers for personal cash card protection.
(vii) In explaining the present invention in detail, in its application of other embodiment and the purpose of description, that in accordance this invention is a superior pre paid cash card. There has never the like. As many ways as you can spend money is as many ways as you can spend a Taylor Corp: Pre-Paid Cash Card Unlimited. The like of which has never been, until now, and this is it. A truly superior First Original, All Public; Pre-Paid Cash Card. A safe way to carry large amounts of cash in a card, in your wallet, on your person. Cash cards that can be spent for cash instantly where you please, when you please or how you please. By use of a utility electronic transfer service.
A secondary bar code is on the back side of the pre-paid cash card. Hidden in the secondary bar code is the track numbers, pin number and ID code That are printed on the front of the cash card. By use of a scanner, the secondary bar code it is much faster to use and to give information contained in the cash card. Pre-Paid Cash Cards can have hidden cash value, activated and posted at the point of purchase. Other cash cards can have a determined cash value, that when value is spent, they then become throw away cash cards. However other cash cards can be renewed rather than throwing away the cash cards. A receipt and balance is give a the point of spending transaction.
(viii) To renew a cash card there is a small user fee, to report a lost or stolen cash card there is a 1-800number to activate, renew or report customer needs.
(ix) A stolen or lost cash card can be replaced by calling the 1-800 number on the back of the cash card or listed on the last receipt. The last receipt will give the last transaction and remaining balance. The person having the receipt and pin # can be issued a new card with the past remaining balance, less a small user fee. And the customer will suffer no lose.
(x) The Library Of Congress, U.S. Copyright Office has issued and given to John D. Taylor and son Steve K. Taylor a Published Registered Certificate Of Copyright and text for Taylor Corp: Pre-Paid Cash Cards Unlimited. Effective register date Mar. 27, 2000. Examiner Michael Goldstein And as granted by copyright law Title 17 as owners with exclusive rights, we reserve the right to change or modify said copyright all rights reserved
